(19) United States
(12) Patent Application Publication
(10) Pub. No.: US 2008/0091438 A1
(43) Pub. Date: Apr. 17, 2008

(54) AUDIO SIGNAL DECODER AND RESOURCE ACCESS CONTROL METHOD

(75) Inventors: Yukio MASUDA, Osaka (JP); Yasuaki HASHIMOTO, Kyoto (JP); Takahisa KOUDA, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/871,336

(22) Filed: Oct. 12, 2007

(30) Foreign Application Priority Data
Oct. 16, 2006 (JP) 2006-281604

(51) Int. Cl. G10L 19/00

(52) U.S. Cl. 704/500; 704/E19.001

(57) ABSTRACT

The audio signal decoder of the present invention includes a first decoding unit which decodes a first encoded audio signal, a second decoding unit which decodes a second encoded audio signal, a memory which stores data under decoding as well as data decoded by the first and second decoding units, and a selection unit which selects one of the first and second decoding units, as a device having access to said memory.

### BACKGROUND OF THE INVENTION

(1) Field of the Invention

The present invention relates to an audio signal decoder which includes a plurality of decoding units capable of decoding plural kinds of encoded audio signals; and a memory for storing both data under decoding by the decoding units and data decoded thereby. The present invention also relates to a resource access control method for use in the audio signal decoder.

(2) Description of the Related Art

In a conventional resource access control method, in order to perform a plurality of processes simultaneously within the same system, each of the processes requires its own resource as shown in FIG. 1. Consequently, in order to reduce required resources, the sharing of a resource for a plurality of processes is carried out (see Japanese Unexamined Patent Application Publication No. H7-44697 for example). Specifically, switching is performed between a plurality of data-access operations, in response to a video vertical synchronizing signal so as to time-share a FIFO, thereby reducing the required buffer size.

### SUMMARY OF THE INVENTION

However, in the case of decoding different kinds of encoded audio signals simultaneously, since there is no common timing for switching as in a video vertical synchronizing signal, and since each of the processes has its own deadline for completion, it is necessary to switch between audio decoding processes at an appropriate timing while sharing a resource. Inappropriate timing of the switching may cause sound degradation (for example, dropout). The system is thus desired, which allows a plurality of decoding units capable of decoding plural kinds of encoded audio signals, to efficiently share a resource with a small capacity.

It is an object of the present invention to provide an audio signal decoder, and a resource access control method, which allow a plurality of decoding units, to efficiently share a resource such as a memory, so as to decode plural kinds of encoded audio signals, thereby reducing required resources.

In order to achieve the above-mentioned object, the audio signal decoder according to the present inventions is an audio signal decoder includes: a first decoding unit which decodes a first encoded audio signal; a second decoding unit which decodes a second encoded audio signal; a memory in which data under decoding as well as data which has been decoded by the first and second decoding units are stored; and a selection unit which selects one of the first and second decoding units, as a device having access to the memory.

This configuration allows the decoding units to share the memory so as to make full use of the memory resource.

Here, it is also possible that the audio signal decoder further includes: a first buffer in which the first encoded audio signal is temporarily held; a second buffer in which the second encoded audio signal is temporarily held; a first determination unit which determines whether or not a first predetermined unitary amount of the first encoded audio signal is held in the first buffer; and a second determination unit which determines whether or not a second predetermined unitary amount of the second encoded audio signal is held in the second buffer, wherein, when a completion notification is outputted from one of the first and second decoding units, the selection unit instructs the other of the first and second decoding units, which did not output the completion notification, to start a process of decoding, the first decoding unit: starts a process of decoding when instructed to start the process of decoding by the selection unit and it is determined that the first predetermined unitary amount of the first encoded audio signal is held in the first buffer, and outputs a completion notification when the process of decoding the first predetermined unitary amount of the first encoded audio signal is completed; and outputs a completion notification when instructed to start the process of decoding by the selection unit and it is determined that the first predetermined unitary amount of the first encoded audio signal is not held in the first buffer, and the second decoding unit: starts a process of decoding when instructed to start the process of decoding by the selection unit and it is determined that the second predetermined unitary amount of the second encoded audio signal is held in the second buffer, and outputs a completion notification when the process of decoding the second predetermined unitary amount of the second encoded audio signal is completed; and outputs a completion notification when instructed to start the process of decoding by the selection unit and it is determined that the second predetermined unitary amount of the second encoded audio signal is not held in the second buffer.

According to this configuration, the selection unit performs switching between the first and second decoding units, in response to the completion notification transmitted from each of the first and second decoding units as a trigger, so that the memory is shared efficiently. Each the first and second predetermined unitary amounts is set to be suitable for its own unitary amount of processing (preferably, based on its audio frame size), thereby improving decoding efficiency. The work area in the memory for holding data under decoding is released as the selection unit performs switching, thereby reducing required memory size. Furthermore, this configuration eliminates the waiting for data input caused by underflow which occurs in the first and second buffers. Specifically, when each of the first and second determination units determines that encoded audio data of a required amount is not held in each of the first and second buffers, no decoding process is performed, thereby preventing the occurrence of processing idle time caused by the waiting for data input.

Here, it is also possible that the audio signal decoder further includes a timer unit which outputs a timeout signal periodically, wherein the selection unit performs switching between the first and second decoding units, in response to the timeout signal outputted from the timer unit.

According to this configuration, it is possible to easily abide by time limits in the decoding process.

Here, it is also possible that the first decoding unit starts decoding the first predetermined unitary amount of the first encoded audio signal when instructed to start a process of decoding by the selection unit, and outputs a completion notification when the decoding of the first predetermined unitary amount of the first encoded audio signal is completed, the second decoding unit starts decoding the second predetermined unitary amount of the second encoded audio signal when instructed to start a process of decoding by the selection unit, and outputs a completion notification when the decoding of the second predetermined unitary amount of the second encoded audio signal is completed, and when a timeout signal is outputted from the timer unit, and a completion notification is outputted from the one of the first and second decoding units which has been instructed to start the process of decoding, the selection unit instructs the other of the first and second decoding units, which did not output the completion notification, to start the process of decoding.

According to this configuration, a time-out period is set according to a unitary amount of processing, thereby making it possible to easily abide by time limits in the decoding process.

Here, it is also possible that the audio signal decoder further includes: a first buffer in which the first encoded audio signal is temporarily held; and a notification unit which notifies an event indicating that the first encoded audio signal held in the first buffer has reached a predetermined amount, when the first encoded audio signal held in the first buffer reaches a predetermined amount, wherein the selection unit selects the first decoding unit when the event is notified from the notification unit, and to select the second decoding unit when a completion notification is received from the first decoding unit, the completion notification indicating that decoding of the predetermined amount of the first encoded audio signal is completed.

According to this configuration, the first decoding unit assures real time operation, while the second decoding unit is suitable for best-effort operation.

Furthermore, the resource access control method according to the present invention is a resource access control method for use in an audio signal decoder having first and second decoding units which decode first and second encoded audio signals respectively, and a memory in which data under decoding as well as data which has been decoded by the first and second decoding units are stored, the resource access control method includes: receiving a completion notification from one of the first and second decoding units, the completion notification indicating that decoding of a predetermined unitary amount of the encoded audio signal is completed; and selecting one of the first and second decoding units as a device having access to the memory, in response to the completion notification.

According to this configuration, it is possible to share the memory between decoding units, and perform switching between the decoding units in response to the completion notification, thereby reducing required memory size.

The present invention allows the decoding units to share the memory, thereby reducing required memory size. According to the present invention, the work area in the memory for holding data under decoding is released as the selection unit performs switching, thereby reducing required memory size. Furthermore, the present invention prevents the occurrence of processing idle time caused by waiting for data input. The present invention makes it easy to abide by time limits. According to the present invention, the first decoding unit assures real time operation, while the second decoding unit is suitable for best-effort operation.

### Further Information about Technical Background to this Application

The disclosure of Japanese Patent Application No. 2006-281604 filed on Oct. 16, 2006 including specification, drawings and claims is incorporated herein by reference in its entirety.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

In the drawings:

FIG. 1 is a block diagram showing a conventional audio signal decoder;

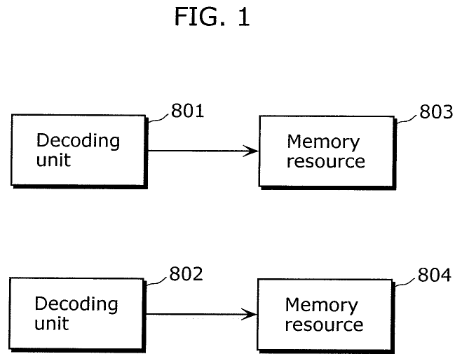

FIG. 2 is a block diagram showing the configuration of an audio signal decoder according to a first embodiment;

FIG. 3A shows a sequence of switching operations to be performed in the audio signal decoder;

FIG. 3B shows another sequence of switching operations to be performed in the audio signal decoder;

FIG. 4 is a flowchart showing a resource access control method according to the audio signal decoder;

FIG. 5 is a block diagram showing the configuration of an audio signal decoder according to a second embodiment;

FIG. 6 shows a sequence of switching operations to be performed in the audio signal decoder;

FIG. 7 is a flowchart showing a resource access control method according to the audio signal decoder;

FIG. 8 is a block diagram showing the configuration of an audio signal decoder according to a third embodiment; and

FIG. 9 shows a sequence of switching operations to be performed in the audio signal decoder.

### DESCRIPTION OF THE PREFERRED EMBODIMENTS

Hereinafter, the embodiments of the present invention will be described with reference to the accompanying drawings.

### First Embodiment

An audio signal decoder according to the first embodiment of the present invention includes first and second decoding units which respectively decode first and second encoded audio signals; a memory which stores data under decoding/decoded by the first and second decoding units; a selection unit which selects either one of the first and second decoding units, as a device which has access to the memory. The selection unit switches between the first and second decoding units, in response to a completion notification, from each of the first and second decoding units, indicating that the decoding process for a predetermined unitary amount is completed. This configuration allows the decoding units to share the memory, thereby reducing required memory size.

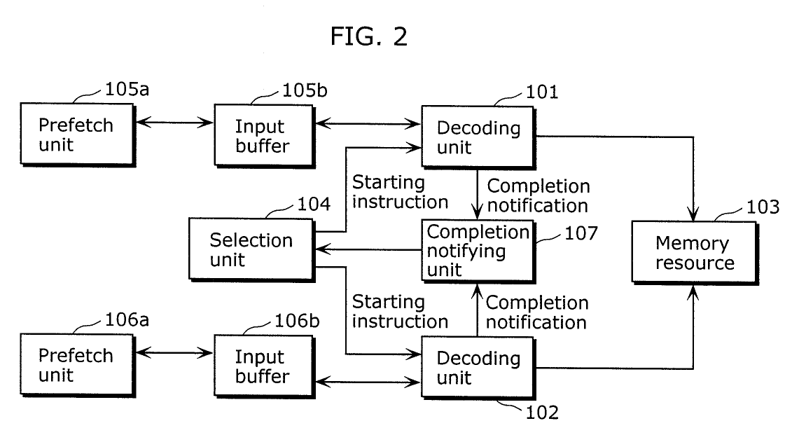

FIG. 2 is a block diagram showing the configuration of the audio signal decoder according to the first embodiment. The audio signal decoder includes decoding units 101 and 102; a memory resource 103; a selection unit 104; prefetch units 105a and 106a; input buffers 105b and 106b; and a completion notifying unit 107. The audio signal decoder decodes two kinds of encoded audio signals simultaneously. The two kinds of encoded audio signals mean, for example, the following pairs: an encoded audio signal recorded in an SD card and an encoded audio signal recorded in an MD; two kinds of encoded audio signals received from a digital broadcasting tuner through different channels; and an encoded audio signal from a digital broadcasting tuner and an encoded audio signal recorded in a recording medium.

The prefetch units 105a and 106a fetch first and second encoded audio signals, from a recording medium or from a digital broadcasting tuner, so as to store the signals in the input buffers 105b and 106b, respectively.

The input buffers 105b and 106b temporarily hold the first and second encoded audio signals, respectively.

The decoding unit 101, which serves as a first decoding unit and a first determination unit, decodes the first encoded audio signal held in the input buffer 105b, on a first predetermined unitary amount basis. Specifically, the decoding unit 101 starts decoding when instructed to start decoding by the selection unit 104 and the first predetermined unitary amount of first encoded audio signal is held in the input buffer 105b. When the decoding of the first predetermined unitary amount of the first encoded audio signal is completed, the decoding unit 101 outputs a completion notification. Furthermore, the decoding unit 101 outputs a completion notification without starting decoding, when instructed to starting decoding by the selection unit and the first predetermined unitary amount of the first encoded audio signal is not held in the input buffer 105b. This eliminates idle time caused by underflow which occurs in the input buffer 105b. The first predetermined unitary amount may be defined by the method in which the first encoded audio signal is encoded.

The decoding unit 102, which serves as a second decoding unit and a second determination unit, decodes the second encoded audio signal held in the input buffer 106b on a second predetermined unitary amount basis. Specifically, the decoding unit 102 starts decoding when instructed to start decoding by the selection unit 104 and the second predetermined unitary amount of the second encoded audio signal is held in the input buffer 106b. When the decoding of the second predetermined unitary amount of the second encoded audio signal is completed, the decoding unit 102 outputs a completion notification. Furthermore, the decoding unit 102 outputs a completion notification without starting decoding, when instructed to start decoding by the selection unit and the second encoded audio signal is not held in the input buffer 106b. This eliminates idle time caused by underflow which occurs in the input buffer 106b. The second predetermined unitary amount may be defined by the method in which the second encoded audio signal is encoded.

The memory resource 103 is accessed by either one of the decoding units 101 and 102, selected by the selection unit 104. The memory resource 103 stores data under decoding/decoded by the decoding units 101 and 102. The decoding units 101 and 102 output a completion notification to each unitary frame, thereby minimizing the work area required for holding data under decoding.

The selection unit 104 selects which one of the decoding units 101 and 102 can obtain access to the memory resource 103.

In response to the completion notification from each of the decoding units 101 and 102, the completion notifying unit 107 notifies the selection unit 104 of such fact.

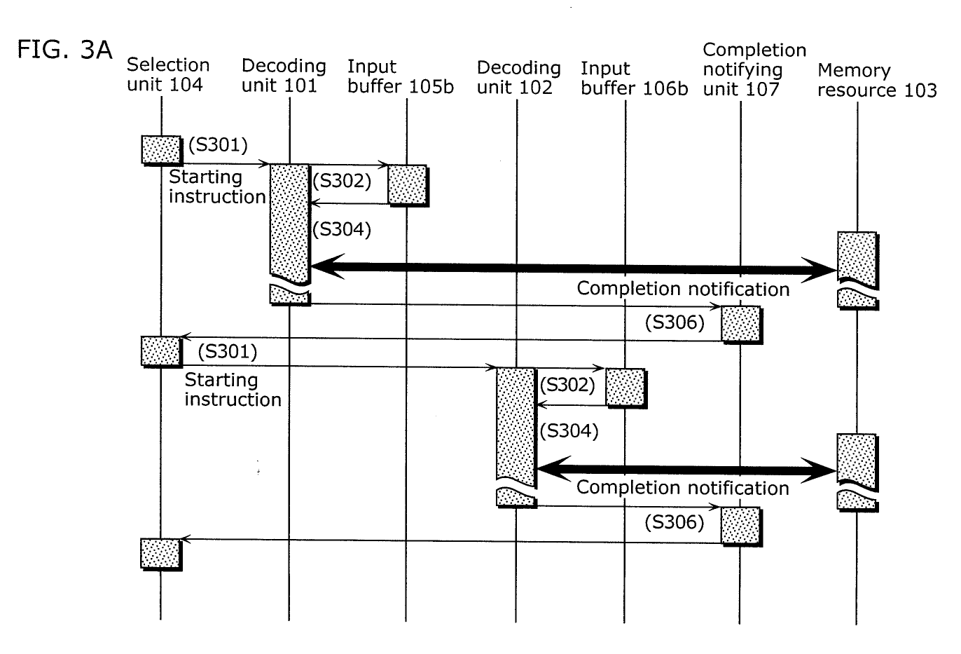

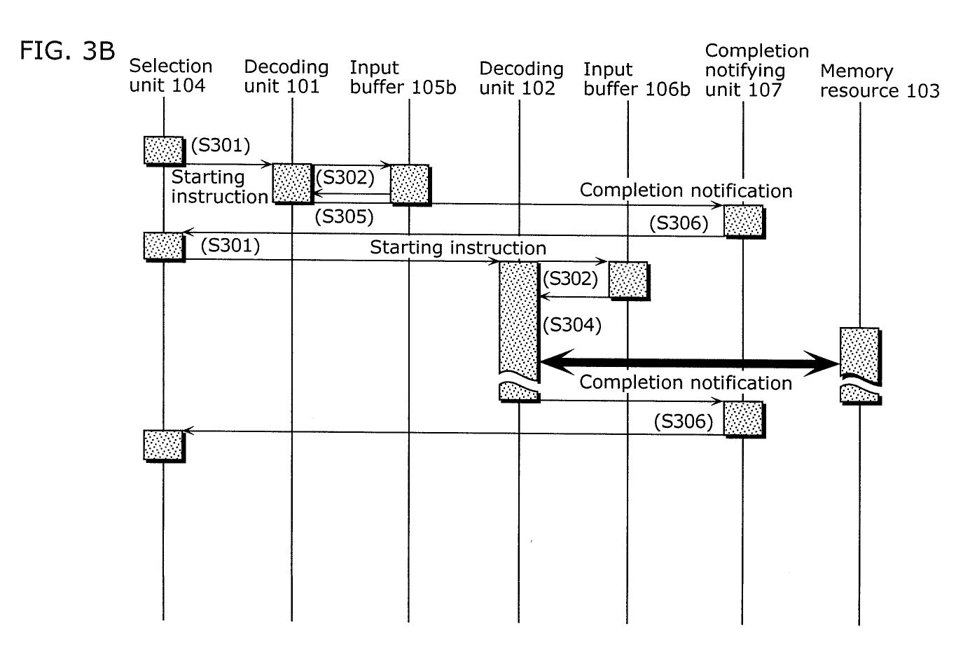

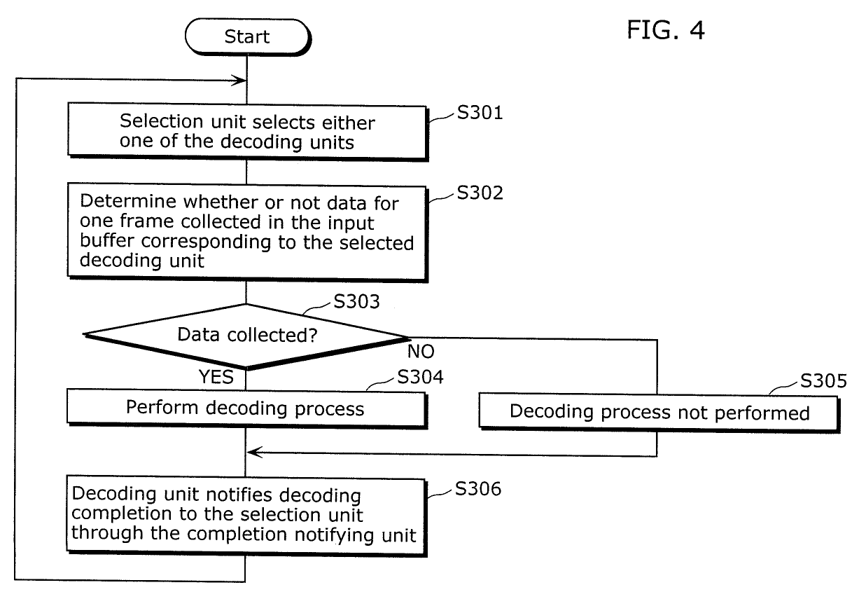

FIG. 3A and FIG. 3B respectively show a sequence of switching operations to be performed in the audio signal decoder. FIG. 4 is a flowchart showing a resource access control method according to the audio signal decoder. In FIGS. 3A and 3B, numbers in parentheses correspond to the steps shown in FIG. 4.

Referring to FIG. 4, the selection unit 104 instructs either the decoding unit 101 or the decoding unit 102 to start a decoding process (S301). The one of the decoding unit 101 and the decoding unit 102 which has been instructed to start a decoding process, determines whether or not the first/second predetermined unitary amount of audio signal is held in the input buffer 105/the input buffer 106b (S302). When it is determined that a sufficient amount of the audio signal is collected to complete the decoding process (S303: YES), the decoding unit 101/the decoding unit 102 obtains access to the memory resource 103 to performs the decoding process (S304). After the completion of the decoding process, the decoding unit 101/the decoding unit 102 notifies the selection unit 104 through the completion notifying unit 107, that the decoding process has completed (S306). FIG. 3A shows the sequence to be performed in this case.

On the other hand, when it is determined that a sufficient amount of the audio signal to complete the decoding process is not collected in the input buffer 105b/106b (S303: NO), the decoding unit 101/decoding unit 102, without performing the decoding process (S305), notifies the selection unit 104 through the completion notifying unit 107, that the decoding process has completed (S306). In response to the notification, the selection unit 104 selects either one from the decoding units again. FIG. 3B shows the sequence to be performed in this case.

As shown in FIG. 3B, a determination is made, before starting a decoding process, whether or not the audio signal of the amount equivalent to one frame is held in either one of the input buffer 105b or the input buffer 106b. When a determination of not held is made, no decoding process is performed, thereby preventing the suspension of processing, during a decoding process, caused by the waiting for data input.

The present embodiment relates to the case in which switching operation is performed between the two decoding units 101 and 102. It is needless to say, however, that switching operation is similarly performed among decoding units of three or larger.

### Second Embodiment

An audio signal decoder according to a second embodiment of the present invention includes a timer unit which outputs a timeout signal periodically. When a timeout signal is outputted from the timer unit, and a completion notification is outputted from one decoding unit instructed to start a decoding process, a selection unit instructs the other decoding unit, different from the decoding unit which has outputted the completion notification, to start a decoding process. This configuration makes it easy to abide by time limits in a decoding process and allows the performance of switching between decoding processes, thereby reducing the required memory size for the system.

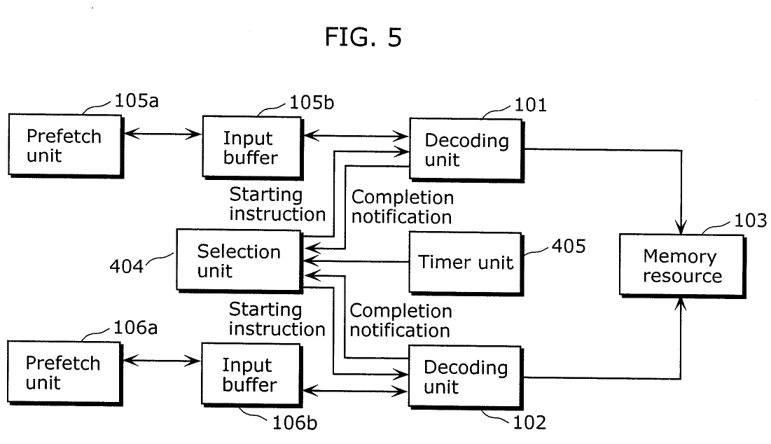

FIG. 5 is a block diagram showing the configuration of the audio signal decoder according to the second embodiment. FIG. 5 is the same as FIG. 2, except that a timer unit 405 and a selection unit 404 are provided, instead of the completion notifying unit 107 and the selection unit 104. Hereinafter, a description is given mainly for this difference; the description for the similar points is omitted here.

A timer unit 405 outputs a timeout signal periodically. This period is preferably set so as to satisfy the deadline by which each of the decoding units 101 and 102 outputs a decoding process result. The timer unit 405 may issue a timer interrupt for input to the selection unit 404.

When a timeout signal is outputted from the timer unit 405, and a completion notification is outputted from one decoding unit most recently instructed to start a decoding process, the selection unit 404 instructs the other decoding unit, different from the decoding unit which has outputted the completion notification, to start a decoding process.

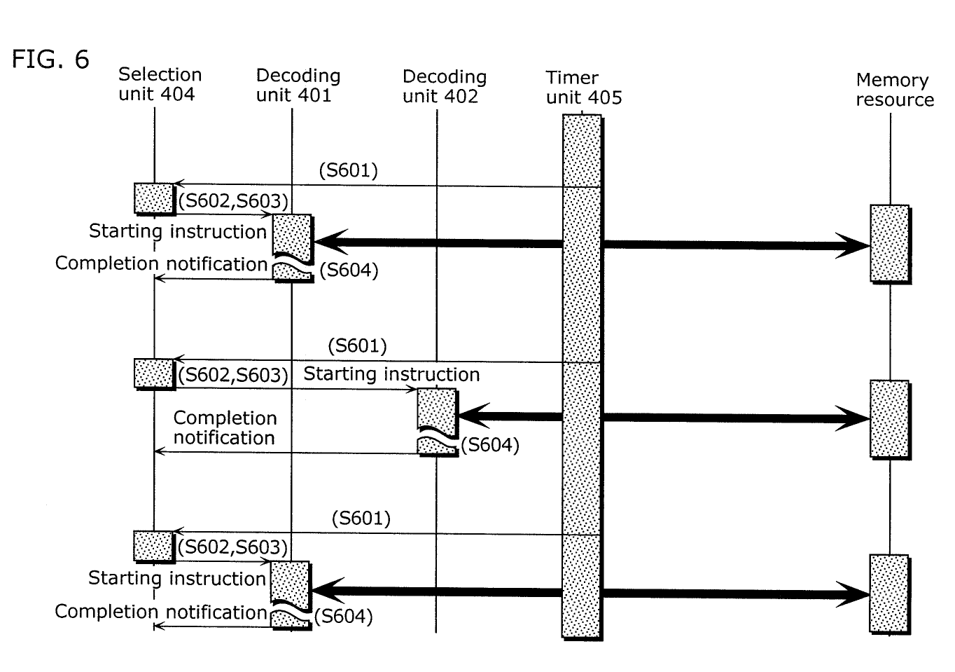

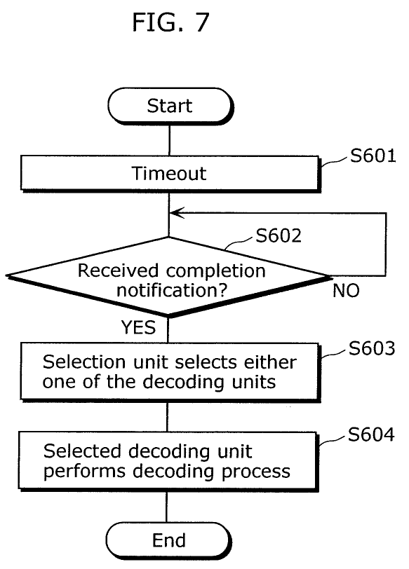

FIG. 6 shows a sequence of switching operations to be performed in the audio signal decoder. FIG. 7 is a flowchart showing a resource access control method according to the audio signal decoder. In FIG. 6, numbers in parentheses correspond to the steps shown in FIG. 7.

Referring to FIG. 7, as the timer unit 405 outputs a timeout signal (S601), the selection unit 404 determines whether or not any completion notification has been received from either the decoding unit 101 (currently selected) or the decoding unit 102 (S602). In the case where any completion notification has been received from either one of the decoding units, the selection unit 404 instructs the other decoding unit to start a decoding process (S603). In the case where no completion notification has been received, the selection unit 404 waits for any completion notification to come. This is because the time interval between the timeout signals is set to be long enough to complete decoding for one frame.

Either one of the decoding units 101 and 102, which has been instructed to start a decoding process, performs a decoding process for one frame, and then outputs a completion notification after the decoding process (S604).

As has been described above, according to the audio signal decoder in the present embodiment, the selection unit 404 performs selection in response to the timeout signal generated by the timer unit, so that switching is performed between decoding processes while abiding by time limits in the decoding process, thereby reducing the required memory size for the system.

In the audio signal decoder according to the present embodiment, the configuration may be such that the decoding unit 101 does not determine whether or not the first encoded audio signal for one frame is held in the input buffer 105b before starting a decoding process. This is because the time interval between the timeout signals is set to be long enough to complete decoding for one frame, even when the first encoded audio signal for one frame is not yet held.

### Third Embodiment

The second embodiment relates to the configuration in which the selection unit starts operating in response to the timeout signal outputted by the timer unit 405. However, in addition to the configuration according to the first embodiment, where decoding process is started by a completion notification, decoding process may be started by a specific event such as the completion of inputting the encoded audio signal for one frame. An audio signal decoder according to a third embodiment of the present invention includes a notification unit which outputs an event notification indicating that the first encoded audio signal held in the input buffer 105b has reached a predetermined amount (equivalent to one frame), when the first encoded audio signal held in the input buffer 105b reaches a predetermined amount. The selection unit performs switching in response to the event notification so as to select the decoding unit 101, while in response to the completion notification from the decoding unit 101 so as to select the decoding unit 102. The selection unit thus gives the higher priority to the decoding unit 101 than the decoding unit 102. This configuration allows the decoding unit 101 to perform real time operation, and the decoding unit 102 to perform best-effort operation.

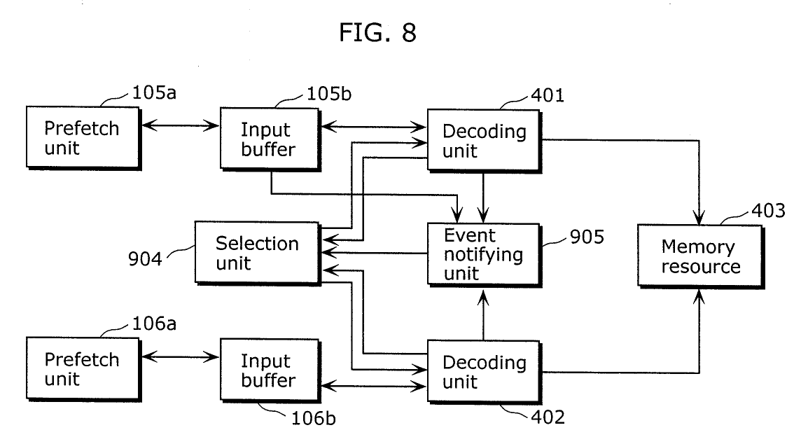

FIG. 8 is a block diagram showing the configuration of the audio signal decoder according to the third embodiment. FIG. 8 is the same as FIG. 6, except that an event notifying unit 905 and a selection unit 904 are provided, instead of the timer unit 405 and the selection unit 404. Hereinafter, a description is given mainly for this difference; the description for the similar points is omitted here.

An event notifying unit 905 monitors the data amount of the first encoded audio signal held in the input buffer 105b, so as to output an event notification indicating that the data has reached the amount equivalent to one frame, when the data reaches the amount equivalent to one frame. Note that the second encoded audio signal held in the input buffer 106b is not monitored.

The selection unit 904 selects the decoding unit 101 in response to the event notification outputted from the event notifying unit 905, and selects the decoding unit 102 in response to the completion notification, received from the decoding unit 101, indicating the completion of the decoding of the first encoded audio signal for one frame. In the case where the decoding unit 102 is in the middle of decoding when an event notification is outputted from the event notifying unit 905, the selection unit 904 selects the decoding unit 101 after forcing suspension or completion on the decoding unit 102.

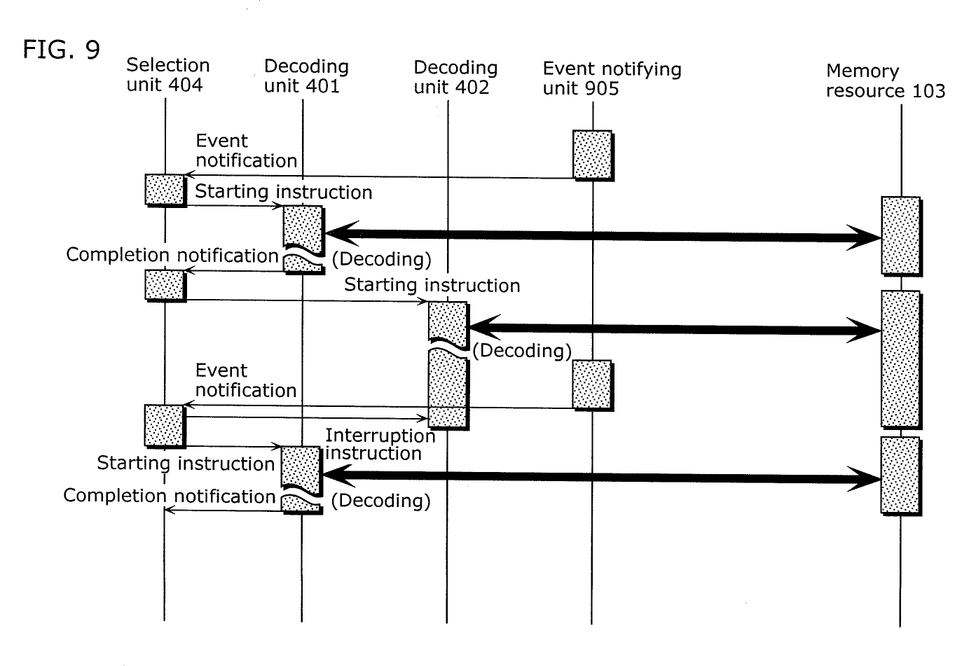

FIG. 9 shows a sequence of switching operations to be performed in the audio signal decoder. As shown in the figure, the selection unit 904 preferentially selects the decoding unit 101 in response to the event notification.

This configuration allows the decoding unit 101 to perform real time operation, and the decoding unit 102 to perform best-effort operation, even in the case where the decoding unit 101 and the decoding unit 102 have low processing capabilities. Taking digital broadcasting as an example, in digital broadcasting, the two types of signals have to be decoded concurrently: an original signal and a data signal. In ordinary cases, while an original signal has to be decoded in real time, a data signal is temporarily held in a storage area and then decoded with best effort. In the present embodiment, selection is switched to original signal decoding in response to the completion of inputting of an original signal, while a data signal is being decoded at the same time. After the completion of original signal decoding, selection is switched again to data signal decoding.

The event at which decoding is started is not limited to the completion of inputting an encoded audio signal for one frame. For example, the event may be the completion of outputting a decoded audio signal for one frame, a few frames ahead of the current frame.

The event notifying unit 905 may monitor the data amount of the second encoded audio signal held in the input buffer 106b, so as to output an event notification indicating that the data has reached the amount equivalent to one frame when the data reaches the amount equivalent to one frame. In the case where the decoding unit 101 and the decoding unit 102 have high processing capabilities, both of the units can perform real time operation.

The above embodiments relate to the case in which the memory is shared as a resource, but the configuration may be such that the decoding units 101 and 102 are shared partially or entirely in addition to the memory.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

### INDUSTRIAL APPLICABILITY

The present invention is applicable to an audio signal decoder which decodes plural kinds of encoded audio signals, and a resource access control method to be performed using the audio signal decoder. Examples of this application include a digital TV set, a digital broadcasting tuner, and an audio player.

What is claimed is:

1. An audio signal decoder comprising:
a first decoding unit operable to decode a first encoded audio signal;
a second decoding unit operable to decode a second encoded audio signal;
a memory in which data under decoding as well as data which has been decoded by said first and second decoding units are stored; and
a selection unit operable to select one of said first and second decoding units, as a device having access to said memory.

2. The audio signal decoder according to claim 1, further comprising:
a first buffer in which the first encoded audio signal is temporarily held;
a second buffer in which the second encoded audio signal is temporarily held;
a first determination unit operable to determine whether or not a first predetermined unitary amount of the first encoded audio signal is held in said first buffer; and
a second determination unit operable to determine whether or not a second predetermined unitary amount of the second encoded audio signal is held in said second buffer,
wherein, when a completion notification is outputted from one of said first and second decoding units, said selection unit is operable to instruct the other of said first and second decoding units, which did not output the completion notification, to start a process of decoding,
said first decoding unit is operable: to start a process of decoding when instructed to start the process of decoding by said selection unit and it is determined that the first predetermined unitary amount of the first encoded audio signal is held in said first buffer, and to output a completion notification when the process of decoding the first predetermined unitary amount of the first encoded audio signal is completed; and to output a completion notification when instructed to start the process of decoding by said selection unit and it is determined that the first predetermined unitary amount of the first encoded audio signal is not held in said first buffer, and
said second decoding unit is operable: to start a process of decoding when instructed to start the process of decoding by said selection unit and it is determined that the second predetermined unitary amount of the second encoded audio signal is held in said second buffer, and to output a completion notification when the process of decoding the second predetermined unitary amount of the second encoded audio signal is completed; and to output a completion notification when instructed to start the process of decoding by said selection unit and it is determined that the second predetermined unitary amount of the second encoded audio signal is not held in said second buffer.

3. The audio signal decoder according to claim 1, further comprising
a timer unit operable to output a timeout signal periodically,
wherein said selection unit is operable to perform switching between said first and second decoding units, in response to the timeout signal outputted from said timer unit.

4. The audio signal decoder according to claim 3,
wherein said first decoding unit is operable to start decoding the first predetermined unitary amount of the first encoded audio signal when instructed to start a process of decoding by said selection unit, and to output a completion notification when the decoding of the first predetermined unitary amount of the first encoded audio signal is completed,
said second decoding unit is operable to start decoding the second predetermined unitary amount of the second encoded audio signal when instructed to start a process of decoding by said selection unit, and to output a completion notification when the decoding of the second predetermined unitary amount of the second encoded audio signal is completed, and
when a timeout signal is outputted from said timer unit, and a completion notification is outputted from the one of said first and second decoding units which has been instructed to start the process of decoding, said selection unit is operable to instruct the other of said first and second decoding units, which did not output the completion notification, to start the process of decoding.

5. The audio signal decoder according to claim 1, further comprising:
a first buffer in which the first encoded audio signal is temporarily held; and
a notification unit operable to notify an event indicating that the first encoded audio signal held in said first buffer has reached a predetermined amount, when the first encoded audio signal held in said first buffer reaches a predetermined amount,
wherein said selection unit is operable to select said first decoding unit when the event is notified from said notification unit, and to select said second decoding unit when a completion notification is received from said first decoding unit, the completion notification indicating that decoding of the predetermined amount of the first encoded audio signal is completed.

6. A resource access control method for use in an audio signal decoder having first and second decoding units which decode first and second encoded audio signals respectively, and a memory in which data under decoding as well as data which has been decoded by the first and second decoding units are stored, said resource access control method comprising:
receiving a completion notification from one of the first and second decoding units, the completion notification indicating that decoding of a predetermined unitary amount of the encoded audio signal is completed; and
selecting one of the first and second decoding units as a device having access to the memory, in response to the completion notification.
